(19) United States
(12) Patent Application Publication
(10) Pub. No.: US 2023/0339226 A1
(43) Pub. Date: Oct. 26, 2023

(54) DROP-ON-DEMAND ELECTROPRINTER WITH A PLUNGING WIRE-IN-A-NOZZLE

(71) Applicants: BWXT NOG Technologies, Inc., Lynchburg, VA (US); Clemson University Research Foundation, Clemson, SC (US)

(72) Inventors: Keith B. RIDER, Prospect, VA (US); Fei PENG, Clemson, SC (US); Konstantin G. KORNEV, Clemson, SC (US)

(21) Appl. No.: 18/110,548

(22) Filed: Feb. 16, 2023

Related U.S. Application Data
(60) Provisional application No. 63/333,587, filed on Apr. 22, 2022.

(51) Int. Cl. B41J 2/045; B41J 2/25; B41J 2/17; B41J 2/21

(52) U.S. Cl. CPC B41J 2/04541; B41J 2/04593; B41J 2/25; B41J 2/0457; B41J 2/1721; B41J 2/2107; B41J 2002/061

(57) ABSTRACT

An electroprinting system having a voltage generator that produces a signal, a drop-on-demand (DOD) droplet generator actuated by the signal of the voltage generator, the drop generator having a wire for submersion into a viscous fluid, a power supply connected to the wire for supplying current to the DOD droplet generator, and a grounded collector for collection of the droplet generated by the DOD droplet generator. The drop-on-demand (DOD) droplet generator has a wire for plunging or threading through a meniscus of a viscous fluid, and an applied electrical potential to form a droplet from the viscous fluid. A method of electroprinting of a viscous fluid is also provided.

### CROSS-REFERENCE TO RELATED APPLICATIONS

This application claims priority from U.S. Provisional Patent Application No. 63/333,587, filed on Apr. 22, 2022, in the United States Patent and Trademark Office. The disclosures of which are incorporated herein by reference in their entireties.

### STATEMENT REGARDING FEDERALLY SPONSORED RESEARCH OR DEVELOPMENT

This invention was made with government support under Contract 80MSFC17C0006 awarded by NASA. The government has certain rights in the invention.

### FIELD OF THE INVENTION

The present invention relates to drop-on-demand (DOD) electroprinting of a viscous fluid, more particularly a high viscosity fluid.

### BACKGROUND OF THE INVENTION

Drop-on-demand (DOD) printing of high viscosity fluids remains a difficult technological problem. As a result, currently, the existing approaches to make particles through emulsion or direct printing are only realized with low viscosity solutions. Furthermore, methods that rely on heat, such as thermoelectric inkjet printers, prevent the use of thermally activated inks.

Thus, the present invention overcomes and solves the following problems preventing successful realization of electroprinting technology: (1) an inevitable formation of a Taylor cone at the droplet surfaces at the very high electric fields. This meniscus singularity causes formation of a plume or spray of tiny droplets thus preventing generation of drops of different sizes on demand; (2) significant viscous drag in syringe pumps used for fluid delivery requiring a much higher-quality of syringe pumps; and (3) controllable breakup of a liquid bridge that the droplet emanating from the nozzles forms with the nozzle.

### SUMMARY OF THE INVENTION

The present invention relates to a drop-on-demand (DOD) droplet generator device that uses a thin wire plunging through a meniscus of a viscous fluid and an applied electrical potential to reliably form small droplets with a narrow size distribution. The total amount of fluid available for the formation of each droplet is controlled by the diameter of the wire and the speed of the plunging action. The droplet formation is driven by an applied electrical potential that produces a charge on the surface of the fluid. When the electrostatic forces overcome the fluid's surface tension, a droplet forms on the end of the wire. The applied potential also creates an electric field that detaches the droplet from the wire and draws it to a nearby collector plate. Wire diameter, wire speed, and applied potential are selected to ensure the reliable detachment of consistent droplets without the formation of smaller, satellite droplets.

In an embodiment of the invention, the drop-on-demand (DOD) droplet generator device has an electromagnetic hammer with an attached wire. Changing the passing current on electromagnetic coils controls acceleration of the hammer with the wire. This way, a wire piercing a liquid bridge sitting in a nozzle, picks up sufficiently thin film and a drop of required hundred microns sizes can be formed on the wire prior to its printing.

In an embodiment of the invention, the drop-on-demand (DOD) droplet generator comprises a wire for plunging or threading through a meniscus of a viscous fluid, and an applied electrical potential to form a droplet from the viscous fluid.

In an embodiment of the invention, a method is provided for generation of droplets that can be made in a variety of sizes, but are also under tight size control as well as a method to avoid nozzle clogging and high pressure pumping through small diameter tubes. The method of the present invention takes a new and inventive approach to making a thin film and forming a drop. In the method of the present invention, the wire is coated with a fluid, such as a sol, by threading the wire through a nozzle filled with the fluid.

The method of the present invention comprises applying a constant DC field. The method comprises detaching the formed drop from the wire avoiding droplet spitting and, hence, printing drops on demand with a frequency in a range of 1 Hz to 3 aHz.

To guide the drop and to break up the liquid tail bridging a mother drop with the wire, one has to generate a special distribution of electric field in this DC mode of the field application. A special insulation of the electromagnetic hammer and its shaft from the target is required. The present invention solves the main challenge in the technology of printing of highly viscous drops of hundreds of microns in diameter.

In an embodiment of the invention, an electroprinting system is provided. The electroprinting system comprises a voltage generator that produces a signal, a drop-on-demand (DOD) droplet generator actuated by the signal of the voltage generator, the drop generator having a wire for submersion into a viscous fluid, a power supply connected to the wire for supplying current to the DOD droplet generator, and a grounded collector for collection of the droplet generated by the DOD droplet generator.

In an embodiment of the invention, a method of electroprinting of a viscous fluid is provided. The method comprises plunging or threading a wire through a meniscus of a viscous fluid, and applying an electrical potential to form a droplet from the viscous fluid.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a schematic drawing of an electrogenerator of droplets on demand in accordance with an embodiment of the present invention.

FIG. 2 is a schematic drawing of the position of a tungsten wire before and after application of the voltage pulse in accordance with an embodiment of the present invention.

FIG. 3A is a view of drop formation in accordance with an embodiment of the present invention.

FIG. 3B is a chart illustrating film thickness versus wire size in accordance with an embodiment of the present invention.

FIG. 4 is an illustration of the smallest voltage needed to pull the drop from the wire in accordance with an embodiment of the present invention.

FIG. 5 is a chart illustrating the relationship between the wire size and critical voltage in accordance with an embodiment of the present invention.

FIG. 6 is an illustration of the dynamics of drop detachment and how the droplet detached from the wire in accordance with an embodiment of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

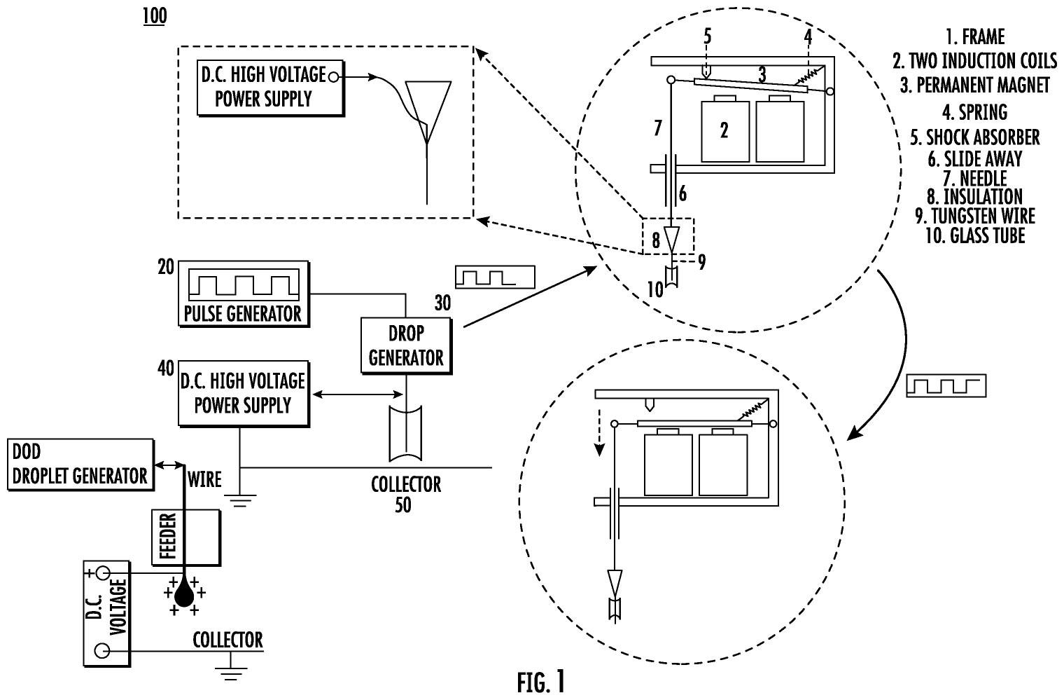

Referring to the figures, FIG. 1 is a schematic of an electrogenerator 100 of droplets on demand of different sizes. Electrogenerator 100 comprises a voltage/pulse generator 20 that produces stepwise voltage pulses with a given frequency. This signal actuates a Drop Generator 30 having an electromagnetic hammer comprised of two induction coils 2 sitting on a metal frame 1 next to each other. When a current is sent to coils 2, the coils attract a magnetic bar 3 hinged to a frame 1. With no current, a spring 4 keeps magnetic bar 3 attached to a shock absorber 5 so that magnetic bar 3 is tilted as shown in FIG. 1 and does not touch the coils. A stainless steel needle 7 is attached to an end of magnetic bar 3 and is guided vertically down through a slide way 6 in a form of a tube. An insulating link 8 is attached to needle 7 from one side and a tungsten wire 9 is attached to the same insulating link 8. In insulating link 8, tungsten wire 9 is bent to stick out as a straight piece piercing a liquid bridge and as a long tail connected to a positive pole of high voltage power supply enabling the drop detachment. The applied voltage depends on the distance between the wire tip and the substrate. At the distance of the order of 1 cm, the applied voltage is greater than 1 kV, at smaller distance the voltage decreases. Insulating link 8 is preferably made of epoxy.

A liquid reservoir in the form of a tube 10, preferably glass, is fixed at an end of the needle-insulator-wire system 7, 8, 9 (referred to herein as the pusher) so that tungsten wire 9 is submersed in the liquid sitting in tube 10. When the current is applied to the coils, magnetic bar 3 moves toward coils 2 and simultaneously pushes needle 7 to move down so that tungsten wire 9 pierces the liquid bridge in the reservoir of tube 10 and sticks out with a liquid film deposited on its surface.

A DC High Voltage Power Supply 40 is connected to tungsten wire 9 and the voltage is always on. Thus, when tungsten wire 9 with a deposited liquid film sticks out from the reservoir of tube 10, the film gets charged and is pulled toward a grounded collector 50. For each voltage pulse, a single droplet is obtained.

A commercially available example of a voltage generator is Pulse generator, MODEL 505, Berkeley Nucleonics Corporation, among others.

A commercially available example of a DC High Voltage Power Supply is Glassman FC series, among others.

Various operational parameters may be modified and still within the scope of the present invention. Examples include, but are not limited to, applied voltage (constant DC voltage, stepped, or ramped, or synchronized with wire motion), counter electrode shape (flat plate, ring, hole in plate), wire and nozzle dimensions (diameter and length), wire motion control (variable speed and acceleration).

The electrogenerator device of the present invention allows for production of spherical droplets from fluids of different viscosities ranging from 10⁻³ Pa*s (such as water) up to 10⁴ Pa*s (such as very thick molasses). The fluids that can be used in the invention include, but are not limited to, a sol-gel such as a high metal ion content sol-gel (e.g. the metal ion concentration in the liquid in the range from 0.01 mol/L to 2 mol/L), liquid metal, polymeric resins, two-phase slurries, and other fluids.

Advantages of the invention include, but are not limited to, DOD printing of high viscosity fluids; small, monodisperse drop sizes; clog resistance; good scalability by increasing the number of wire-nozzles attached to a single actuator; adaptable to a variety of fluids with different viscosity, chemical reactivity, surface tension, and density characteristics; among other advantages.

Examples of uses of the device of the present invention include, but are not limited to, ceramic microsphere production, micro soldering electronics, high resolution production of screen printing masks, precision dosing of high viscosity chemicals, and high resolution additive manufacturing, among other uses.

### Example—Fluid Details

An example illustrating the successful printing of ceramic sols conducted with the drop electrogenerator of the present invention is set forth below. The properties of the sol are provided in Table 1.

TABLE 1
Composition list of Ba—Ce—Fe-based sol

| Amount | | Chemicals | Supplier |
|---|---|---|---|
| 50 | ml | Acetic acid, | Aqua Solutions, |
| | | Glacial Reagent | Inc. |
| 7 | ml | Ammonium hydroxide | Sigma-Aldrich |
| | | solution, 28.0-30.0% | |
| | | NH₃ basis | |
| 4.04 | ml | 2,4-Pentanedione, 99% | Alfa Aesar |
| 19 | ml | DI water | N/A |

| | | |
|---|---|---|
| 0.01 mol (2.554 g) | Barium acetate | Alfa Aesar |
| 0.005 mol (1.7214 g) | Cerium (III) acetate | Alfa Aesar |
| | sesquihydrate, 99.9% | |
| 0.005 mol (2.02 g) | Iron (III) nitrate | Alfa Aesar |
| | nonahydrate, 98+% | |

All materials of the composition of Table 1 were added to a boiling flask, and a magnetic stirrer mixed the mixture continuously to make the solution homogeneous. Several minutes later, the glass container was placed in an oil bath at 80 degree Celsius to reflux the Ba—Ce—Fe-based solution for 5 hours. The Ba—Ce—Fe-based solution was cooled down to room temperature before the next step. Next, 36 ml DI water was added into the solution, the magnetic stirrer was still working at the mean time. DI water was added into the flask gently and slowly to avoid the fast-hydrated reaction. The pH of solution was less than 4.0 at this moment. Several drops of ammonia were added to adjust the pH to around 4.10. The solution was divided into several equal portions and stored in 20 ml glass bottles, respectively. A highly-viscous (10² Ps*s to 10⁴ Ps*s) ceramic precursor was obtained by concentrating the solution in the oven at 80 degree Celsius for at least 50 hours.

To appreciate the high viscosity effect of the sol in question, a vial was flipped with the Ba—Ce—Fe-based ink and a vial filled with water at the same time, water fell down and filled the bottom instantaneously, while after about 45 seconds the Ba—Ce—Fe-ink was still flowing over the wall on its way to the bottom.

Table 2 is an illustrative comparison between the Ba—Ce—Fe based sol (BCF) and DI water. All parameters were measured using Kruss DSA and Brookfield DV3T Rheometer.

TABLE 2
Rheometer

| | density | surface tension | dynamic viscosity |
|---|---|---|---|
| | (kg/m³) | (N/m) | (Pa · s) |
| Sample | 1.28 × 10³ | 37 × 10⁻³ | 10 |
| DI water | 1.00 × 10³ | 72.00 × 10⁻³ | 0.001 |

The Ba—Ce—Fe-based ink did not show any shear thinning or shear thickening properties.

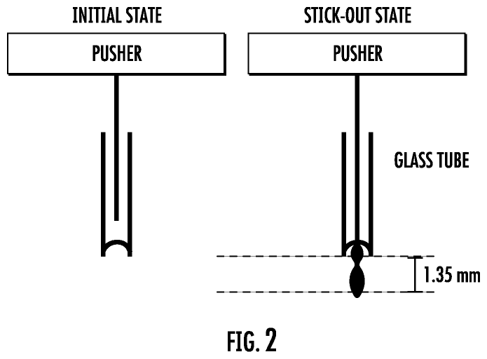

In the electrogenerator of the present invention, the drops were formed spontaneously on the surface of tungsten wire due to the capillary instability of cylindrical films as illustrated in FIG. 2. FIG. 2 is a schematic of the position of a tungsten wire before and after application of the voltage pulse. The wire was moving with velocity of approximately 340 mm/s. The internal diameter of the glass tube holding the liquid bridge was 1.05 mm.

In the initial state, when the needle-insulator-wire system 7, 8, 9 (the pusher) in FIG. 1 was at rest, the tungsten wire was submersed in the liquid bridge sitting inside the glass tube 10 in FIG. 1. After current application to the coils 2 in FIG. 1, the pusher pulled the tungsten wire down forcing it to pierce the meniscus and formed the film on its surface which then transformed into a drop. The tungsten wire was typically sticking out from the glass tube at 1.35 mm distance allowing a single drop to form on its surface.

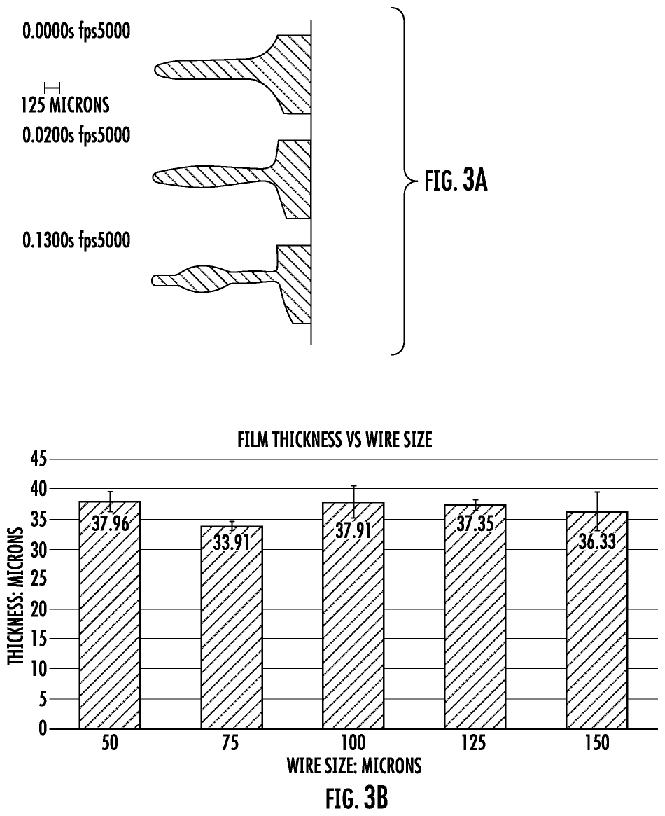

As schematically shown in FIG. 2, on its way through the feeder filled with the sol, the wire picked up a thin film. Due to the capillary instability, the film turned into a mother drop as shown in FIG. 3A. The applied DC voltage pulled the droplet to the tip of the wire and forced it to fly toward the collector.

The drop formation, as shown in FIG. 3A, was filmed with a high speed-motion camera (MotionProX3, Integrated Design Tools, Inc., Tallahassee, FL) at 5000 fps. The chart in FIG. 3B illustrated film thickness versus wire size and proved the robustness of the method of film generation. The wires of 50, 75, 100, 125, and 150 μm in diameter formed the film of almost the same thickness (the wire speed was 340 mm/s, stick-out thickness was 1.35 mm, glass tube diameter was 1.05 mm).

As shown in the chart, the process of film formation was highly repeatable and did not depend on the size of the tungsten wire, FIG. 3B.

Once the film has been formed, it started to undulate to form a drop as shown in FIG. 3A. This drop was then moved to the wire tip by applying a DC field. The drop came to the wire end, but did not necessarily leave the wire. A voltage needed to be applied to a voltage above a certain value to detach the drop from the wire. The certain voltage was investigated and defined as the smallest voltage needed to pull the drop from the wire as illustrated in FIG. 4. The shapes of droplets which were about to leave the wires of different diameters; the wire diameter was shown above each wire. The films on the wires were obtained at the same wire velocity, approximately 340 mm/s.

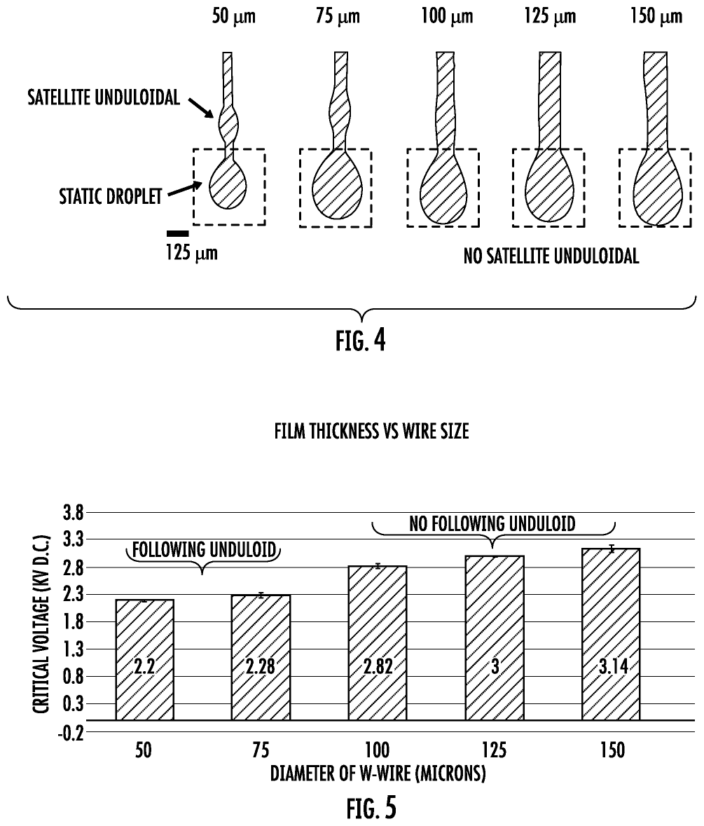

The certain voltage needed to detach the drop from the wire was determined for each wire. Rising the voltage 0.1 kilovolts higher than the critical voltage, ensured that the drop would leave the wire. A summary of the experiments is in FIG. 5.

FIG. 5 illustrates the relation between the wire size and critical voltage. The distance between the wire tip and the grounded electrode was 3 cm. The obtained drop sizes were 250, 350, 350, 350, 450 μm, respectfully.

These results suggested that the larger the wire diameter, the greater the critical voltage for the drop detachment. The most attractive wire diameters were above 100 μm where no satellite droplets were observed. Therefore, each voltage pulse generated a single droplet. As the wire diameter decreased, the mother droplet was followed by a satellite droplet which was formed when a thin liquid bridge connecting the drop and the wire broke. The satellite drop collected the remaining fluid.

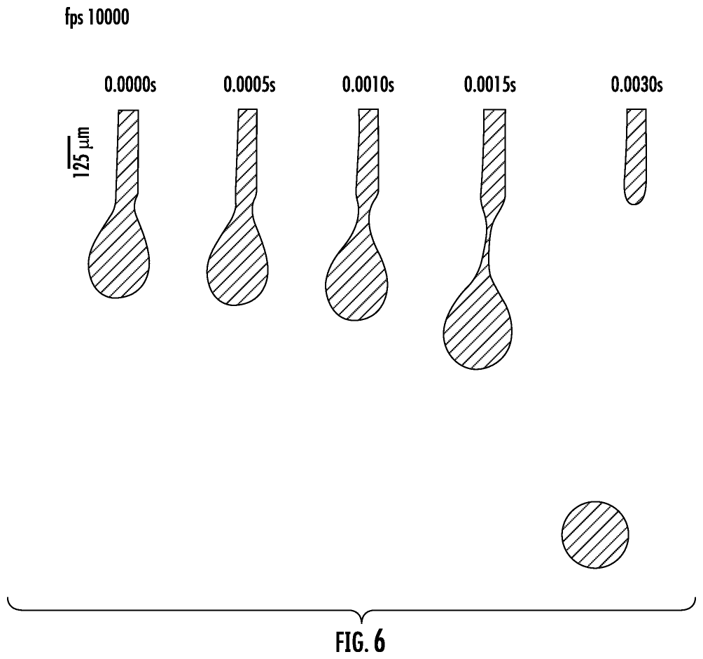

FIG. 6 is an illustration of the dynamics of drop detachment and how the droplet detached from the wire. The tail connecting the drop and wire was not that large and eventually broke. The results confirmed that highly viscous sols (preferably in the viscosity range of 10² Ps*s to 10⁴ Ps*s) could be successfully printed with the developed DOD electrogenerator of the present invention.

The distance between electrodes was fixed at 3 cm, and the stick-out length of the wire was 1.35 mm. Applied voltage was 3 KV.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An electroprinting system comprising:
a voltage generator that produces a signal,
a drop-on-demand (DOD) droplet generator actuated by the signal of the voltage generator, the drop generator having a wire for submersion into a viscous fluid,
a power supply connected to the wire for supplying current to the DOD droplet generator, and
a grounded collector for collection of the droplet generated by the DOD droplet generator.

2. The system according to claim 1, wherein the power supply is a DC High Voltage Power Supply.

3. The system according to claim 1, wherein the fluid is selected from the group consisting of a sol-gel, liquid metal, polymeric resin, two-phase slurry, and a combination thereof.

4. The system according to claim 1, wherein the fluid has a viscosity ranging from 10⁻³ Pa*s up to 10⁴ Pa*s.

5. The system according to claim 1, wherein the droplet is spherical.

6. A drop-on-demand (DOD) droplet generator comprising:
a wire for plunging or threading through a meniscus of a viscous fluid, and
an applied electrical potential to form a droplet from the viscous fluid.

7. The drop-on-demand (DOD) droplet generator according to claim 6, wherein the fluid is selected from the group consisting of a sol-gel, liquid metal, polymeric resin, two-phase slurry, and a combination thereof.

8. The drop-on-demand (DOD) droplet generator according to claim 7, wherein sol-gel has a high metal ion content.

9. A method of electroprinting of a viscous fluid, the method comprising:
plunging or threading a wire through a meniscus of a viscous fluid, and
applying an electrical potential to form a droplet from the viscous fluid.

10. The method according to claim 9, wherein plunging or threading the wire occurs at an accelerating speed.

11. The method according to claim 9, wherein the applied electrical potential produces a charge on a surface of the viscous fluid.

12. The method according to claim 9, wherein the droplet forms on an end of the wire when an electrostatic force overcomes surface tension of the viscous fluid.

13. The method according to claim 9, wherein the applied electrical potential creates an electric field that detaches the droplet from the wire.

14. The method according to claim 9, wherein the detached droplet is drawn to a collector plate.

15. The method according to claim 9, wherein a total amount of fluid available for the formation of each droplet is controlled by a diameter of the wire.

16. The method according to claim 9, wherein a total amount of fluid available for the formation of each droplet is controlled by speed of the plunging action.

17. The method according to claim 9, wherein a droplet is printed with a frequency in a range of 1 Hz to 3 Hz.

18. The method according to claim 9, wherein the droplet is spherical.

19. The method according to claim 9, wherein the fluid has a viscosity ranging from 10⁻³ Pa*s up to 10⁴ Pa*s.

20. The method according to claim 9, wherein the fluid is selected from the group consisting of a sol-gel, liquid metal, polymeric resin, two-phase slurry, and a combination thereof.

21. The method according to claim 9, wherein the sol-gel has a high metal ion content.

22. The method according to claim 9, wherein the droplet is used in a field selected from the group consisting of ceramic microsphere production, micro soldering electronics, high resolution production of screen printing masks, precision dosing of high viscosity chemicals, high resolution additive manufacturing, and a combination thereof.
